(19) United States
(12) Patent Application Publication
(10) Pub. No.: US 2025/0291339 A1
(43) Pub. Date: Sep. 18, 2025

(54) AUTOMATIC WORK LINE CONTROL DEVICE AND CONTROL METHOD THEREFOR

(71) Applicant: HITACHI, LTD., Tokyo (JP)

(72) Inventors: Yutaka NAGAI, Tokyo (JP); Sanato OHTOSHI, Tokyo (JP); Kei UTSUGI, Tokyo (JP); Issei SUEMITSU, Tokyo (JP)

(21) Appl. No.: 18/860,736

(22) PCT Filed: Feb. 24, 2023
(86) PCT No.: PCT/JP2023/006646

§ 371 Date: Oct. 28, 2024

(30) Foreign Application Priority Data
Aug. 31, 2022 (JP) 2022-138794

(51) Int. Cl. G05B 19/418; B25J 9/16

(52) U.S. Cl. CPC G05B 19/41865; B25J 9/1633

(57) ABSTRACT

A controller of a control device that controls an automatic work line including a plurality of mechanical operating devices generates a work plan based on work instruction information including a work amount of a work plan target time unit of the automatic work line, outputs the generated work plan, and controls torque of each of the plurality of mechanical operating devices over a target period of the work plan based on the work plan of each of the plurality of mechanical operating devices.

### TECHNICAL FIELD

The present invention relates to an automatic work line control device and an automatic work line control method for continuously and automatically advancing various works such as manufacturing and conveyance.

### BACKGROUND ART

Automatic work lines such as an automatic manufacturing line and an automatic conveyance line are known as automated systems for production, conveyance, and the like of products. The automatic work line includes a line that continuously moves a plurality of work target objects, and industrial machines such as robots and conveyors that apply automatic work to the work target objects are arranged along the line.

An automatic work line control device attempts to quickly drive an industrial machine in accordance with movement of a target object in order to maximize efficiency of production and conveyance. However, when the acceleration at the time of driving increases, a mechanical shock in a driving unit increases, and the life of the industrial machine is shortened.

Therefore, in order to realize control that can be adjusted to suppress an impact generated in a machine as much as possible while keeping a processing time within a takt time, a numerical control device includes a program analyzing unit that analyzes a processing program and outputs command data, an impact analyzing unit that acquires a maximum value of the impact generated in the machine at a time of executing the processing program, an acceleration/deceleration time constant specifying unit that specifies an acceleration/deceleration time constant of a place where the maximum value of the impact is generated based on the command data in a case where the maximum value of the impact exceeds a predetermined threshold value, an acceleration/deceleration time constant changing unit that changes the specified acceleration/deceleration time constant by using a time constant adjustment value set in advance, a cycle time recalculating unit that calculates a cycle time of the processing program based on the changed acceleration/deceleration time constant, and an update time constant storage unit that stores the changed time constant in association with a specified command block in a case where the recalculated cycle time is within the takt time set in advance (PTL 1).

### CITATION LIST

### Patent Literature

PTL 1: JP 2016-151951 A

### SUMMARY OF INVENTION

### Technical Problem

In the prior art, although the processing time is maintained within the takt time, the impact generated in the machine when the maximum value of the impact generated in the machine at the time of executing the processing program exceeds the predetermined threshold value is just suppressed as much as possible. Therefore, it is not possible to avoid the type of fatigue that accumulates every day although the maximum value of the impact generated in the machine is equal to or less than the predetermined threshold value.

Therefore, a target object of the present invention is to provide a control device and a control method therefor for enabling a life of a component of an automatic work line to further extend while the automatic work line achieves a work plan for daily production, conveyance, and the like.

### Solution to Problem

In order to achieve the target object, the present invention is an invention for controlling an automatic work line including a plurality of mechanical operating devices, the invention including: generating a work plan based on work instruction information including a work amount of a work plan target time unit of an automatic work line; outputting the generated work plan; and controlling torque of each of the plurality of mechanical operating devices over a target period of the work plan based on the work plan of each of the plurality of mechanical operating devices.

### Advantageous Effects of Invention

According to the present invention, it is possible to provide a control device and a control method therefor for enabling a life of a component of an automatic work line to further extend while the automatic work line achieves a work plan for daily production, conveyance, and the like.

### BRIEF DESCRIPTION OF DRAWINGS

FIG. 1 is a block diagram of a control device and an automatic work line.

FIG. 2 is an example of a database.

FIG. 3 illustrates an outline of a five-axis robot.

FIG. 4 is an example of a flowchart related to an operation in which a controller of the control device executes a program.

FIG. 5 is a graph showing a drive operation pattern of shafts on each axis of the robot illustrated in FIG. 3.

FIG. 6 is an example of a timing chart of a plurality of work processes belonging to the automatic work line.

FIG. 7 is a flowchart illustrating details of a torque setting process (FIGS. 4, S104, 105, and 110).

FIG. 8 is a schematic diagram illustrating a form in which a plurality of industrial machines (mechanical operating devices) are arranged in the automatic work line.

FIG. 9 is a flowchart illustrating reduction of practical torque of the industrial machine.

FIG. 10 is a schematic diagram illustrating a state in which the plurality of industrial machines are installed in parallel on a line.

FIG. 11 is a flowchart for managing maintenance of a plurality of industrial machines.

FIG. 12 is a flowchart for a controller that optimizes the torque of the industrial machine based on a weight of a target object.

FIG. 13 is a model diagram related to a behavior of the five-axis robot.

FIG. 14 is a flowchart for selecting a track of an arm of the robot.

FIG. 15 is a flowchart for managing a life of each operation unit of the mechanical operating device.

### DESCRIPTION OF EMBODIMENTS

Hereinafter, an embodiment of a control device according to the present invention will be described with reference to the drawings. The control device includes, for example, a computer, and a controller of the computer executes a program of a memory to realize control of an automatic line for work such as manufacturing and conveyance.

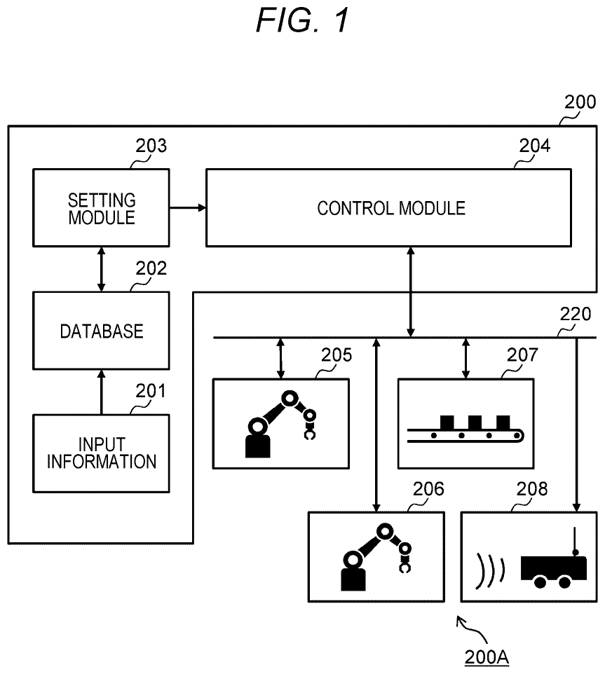

FIG. 1 is a block diagram of an entire system including a control device 200 and an automatic work line 200A. The automatic work line 200A includes a line 220 that continuously moves a plurality of work target objects for work such as manufacturing, conveyance, and processing, and a plurality of mechanical operating devices 205 to 208 arranged to be adjacent to the line 220.

Each of the industrial machines 205 to 208 executes work such as production, conveyance, and processing of a target object moving along the line 220, and related work. The control device 200 controls torque as drive characteristics of each of the plurality of industrial machines 205 to 208. Each of the industrial machines 205 to 208 is a mechanical operating device including a rotation shaft, an operation unit such as a slider, or an operation mechanism. A host device such as the computer controls drive characteristics such as torque (load torque or drive torque) for driving each of a plurality of operation units across a plurality of industrial machines.

As the plurality of industrial machines 205 to 208, for example, the reference signs 205 and 206 denote a robot, the reference sign 207 denotes a conveyor, and the reference sign 208 denotes an automatic guided vehicle. The automatic guided vehicle 208 carries a target object of processing work to the robot 205. The robot 205 performs first processing on the target object. The conveyor 207 conveys the target object passing through the first processing to the robot 206. The robot 206 performs second processing on the target object, and the automatic guided vehicle 208 then carries the target object out of the automatic work line. The automatic work line includes five work processes from carrying-in to carrying-out of a target object. Work on a target object is ended by one target object sequentially moving through these processes.

The control device 200 controls driving of an operation unit, for example, a rotation shaft of the industrial machine to be able to exert torque capable of handling a standard work amount (referred to as a standard amount below) per unit period, in other words, per work plan target time unit, for example, 1000 target objects per day. This torque is referred to as standard torque. The unit period is, for example, one day (eight hours). The standard amount described above is determined to obtain the maximum work amount in a range in which each of the plurality of industrial machines do not exceed the allowable torque.

The control device 200 includes a setting module 203 that sets torque for each industrial machine and a control module 204 that controls the industrial machine based on the set torque. For example, the setting module 203 generates a work plan based on input information 201 related to a work plan and management information of the database 202, and determines the torque value of each of a plurality of operation units based on the work plan. The input information 201 includes the date of work, and plan data regarding work such as production and conveyance, particularly, the number of products and the number of conveyance. The input information 201 is registered in the database 202 by a user or a manager via an input device/input means. The setting module 203 sets torque necessary for processing the number of works on the working day. The database 202 and the setting module 203 correspond to means for generating a work plan in claim 1. The setting module 203 and the control module 204 correspond to the means for controlling the torque in claim 1. The generated work plan is output to the user or the manager by a display drive circuit and a display device (output means).

Note that the module is a function realized by a controller such as a CPU of a computer executing a program, and may be paraphrased as another term such as means, a unit, a portion, or a circuit. The module may be replaced with dedicated hardware such as a chip.

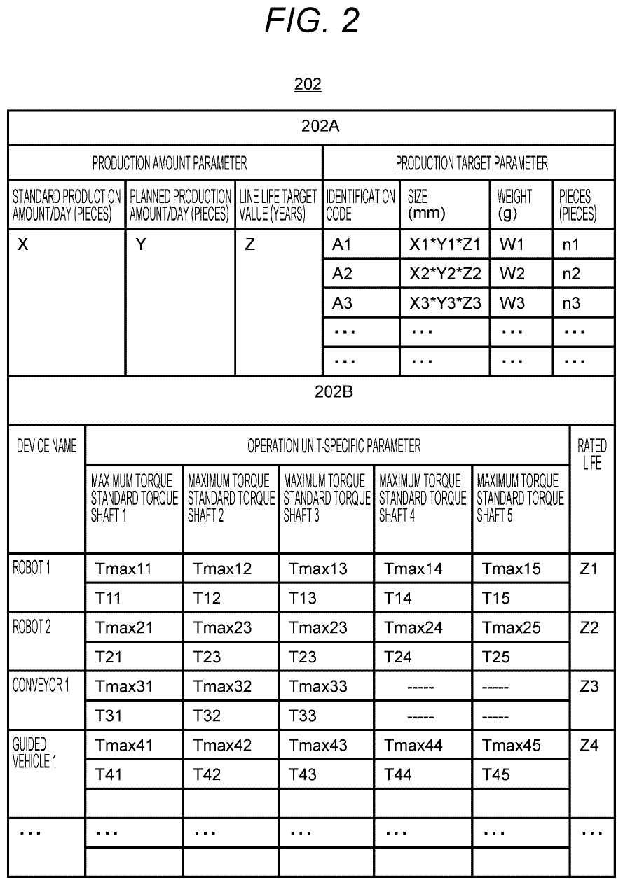

FIG. 2 illustrates an example of the database 202. The database 202 includes an area 202A of data related to a plan of work (production) and an area 202B of parameters related to attributes of industrial machines (device names) constituting the automatic work line. A production amount parameter of the area 202A includes a standard production amount X, a planned production amount (scheduled production amount) Y (FIG. 1: 201) on the work day, and a life target Z of the automatic work line. The standard production amount X is, for example, 1000 pieces/day, and the planned production amount Y is, for example, 600 pieces/day.

The production target parameter is a parameter related to an attribute of a target object of production work, and includes an identification code A1 . . . , a size X1*Y1*Z1 . . . , a weight W1, and a number n1 . . . .

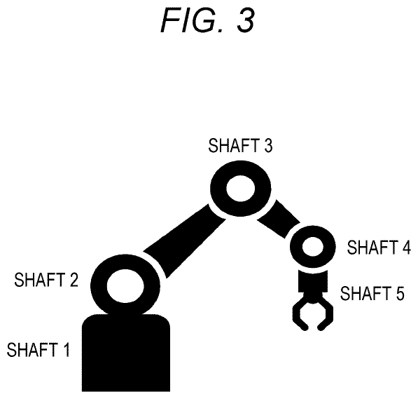

The area 202B includes an industrial machine name (element), the maximum torque (Tmax) and a standard torque (T) which are parameters for each of a plurality of operation units (shafts) of the industrial machine, and a rated life of the industrial machine. Industrial machines, such as robots, are guaranteed to be operable at maximum torque to their rated life. For example, in the robot 1, in a case where a portion having the shortest life is the shaft 2, it is ensured that the shaft 2 is rotated to the rated life under the condition of the maximum torque Tmax12. FIG. 3 illustrates an outline of a form of the robot, and illustrates that the robot has five operation units (shafts).

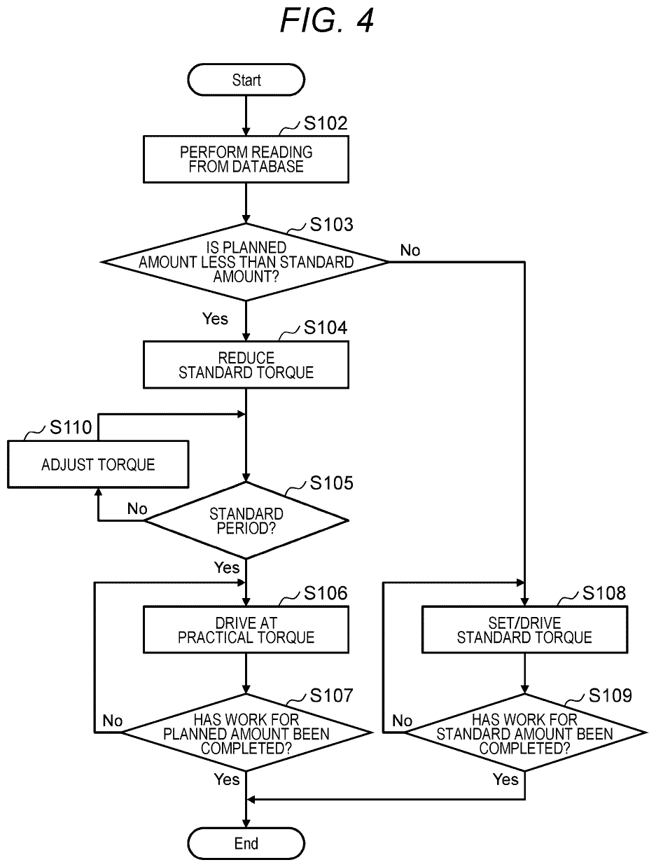

FIG. 4 is an example of a flowchart related to an operation in which a controller of the control device 200 executes a program. The controller starts the flowchart at a predetermined time before work on the planned date. The controller reads the planned amount of work (planned production amount) Y and the standard amount X from the database 202 (S (step) 102). The manager registers the planned amount on the work plan date in the database 202 in advance.

Next, the controller proceeds to S103, and compares the planned amount with the standard amount to determine whether or not the planned amount is less than the standard amount. When it is determined that the planned amount is not less than the standard amount (S103: No), the controller proceeds to S108.

In S108, the controller refers to the database 202 for each of the plurality of industrial machines to set a standard torque for each industrial machine (setting module: 203), and drives the plurality of industrial machines according to the standard torque (control module: 204).

In S109, the controller continues S108 until it is determined that the standard amount of work (production) has been completed, that is, the standard period has elapsed. When affirmative determination is made in S109, the controller ends the flowchart.

The value of the torque is obtained by multiplying the weight of the work target object, the acceleration of the operation unit (rotation acceleration of the shaft), and the operation range (rotation radius of the shaft). A drive circuit of the industrial machine can control the torque of the industrial machine by changing the rotation acceleration and/or the rotation radius under the control of the controller.

When determining that the planned amount is less than the standard amount in S103 (S103: YES), the controller proceeds to S104. In S104, the controller sets torque having a value less than the standard torque for each of the plurality of industrial machines. For example, the controller reduces the standard torque of each of the plurality of devices based on the ratio of the planned amount with respect to the standard amount, and sets the reduced standard torque for each of the plurality of devices.

Then, the controller proceeds to S105, simulates all processes of the automatic work line based on the torque set for each of the plurality of devices in S104, and calculates a required period until the work on the planned amount is completed.

The controller compares the required period with the standard period. When the required period is out of a range of the standard period to (x is a predetermined error) (S105: No), the process returns to S105 after adjustment of increasing or decreasing the torque in S104 (S110).

When an affirmative determination is made in S105, the controller sets the generated torque as the practical torque, and proceeds to S106. As a result of S105, the controller can make the required period substantially equal to the standard period even if the planned amount is less than the standard amount.

In S106, the controller drives the industrial machine based on the practical torque, and proceeds to S107. The controller continues S106 until it is determined that the planned amount of work (production) has been completed, that is, the required period has elapsed. When affirmative determination is made in S107, the controller ends the flowchart. According to the flowchart of FIG. 4, there is realized an automatic work line control device in which an industrial machine provided along a line continuously executes work on a plurality of target objects continuously moving on the line, the automatic work line control device including a controller that controls the industrial machine based on a program stored in a memory, in which the controller reduces the torque for driving the industrial machine from the standard value based on the plan of the work on the plurality of target objects, and drives the industrial machine at the reduced torque until the work based on the plan is completed. As a result, it is possible to further extend the life of the component of the automatic work line while the automatic work line achieves a daily work plan for production, conveyance, and the like.

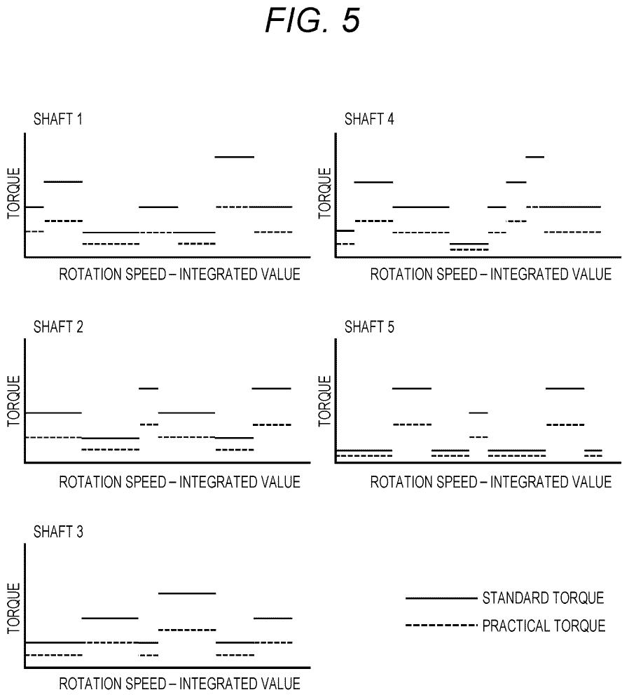

FIG. 5 is a graph showing a drive operation pattern of shafts on each axis of the robot illustrated in FIG. 3. The vertical axis represents a torque value of the shaft of the robot, and the horizontal axis represents a rotation speed integrated value indicating how many times the shaft of the robot has rotated in total. Further, a solid line indicates a variation pattern of the standard torque, and a dotted line indicates a variation pattern of the practical torque. The control device 200 causes the standard torque to vary based on the rotation speed integrated value of the shaft. The control device 200 reduces the variation pattern of the standard torque by a predetermined ratio and sets the pattern of the practical torque. For example, in a case where the standard amount is set to 1000 pieces and the planned amount is set to 600 pieces, the control device 200 subtracts the load torque of each of the plurality of industrial machine instruments to the practical torque of (standard torque)×(600/1000) according to S104, 105.

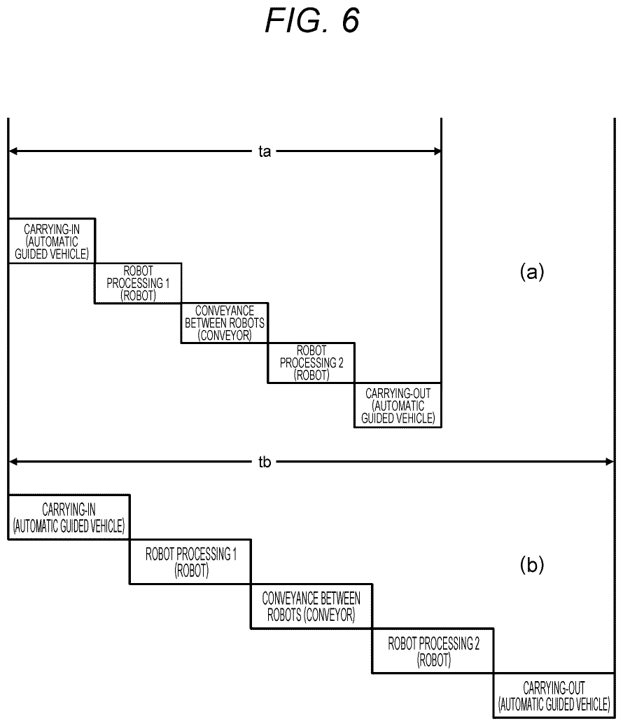

FIG. 6 is an example of a timing chart of a plurality of work processes belonging to the automatic work line, and work on a target object is completed when one target object sequentially passes through a plurality of work processes. (a) illustrates a pattern in a case where the industrial machine is driven at the standard torque, and (b) illustrates a pattern in a case where the industrial machine is driven at the practical torque. As illustrated in the figure, even if the torque of each of the plurality of industrial machines is reduced from the standard torque to the practical torque in flexibly accordance with the planned amount that can be changed by the control device every day, the cycle time of each process is extended, and the time required for the work of one target object is extended from ta to tb, the life of the industrial machine can be extended while maintaining the work efficiency, if the work of the target object of the planned amount is within the standard period.

The life of the industrial machine is reduced in inverse proportion to the accumulation of the torque of the operation unit, for example, a value obtained by integrating the torque of the rotation shaft with the accumulated rotation speed. For example, in the case of a ball bearing structure, the life is inversely proportional to the 10/3 power of the integral of the torque, or in the case of a roller bearing structure, the life is inversely proportional to the third power of the integral of the torque. The life of the industrial machine can be extended by reducing the torque. The life of the shaft having the largest torque integrated value is the life of the device.

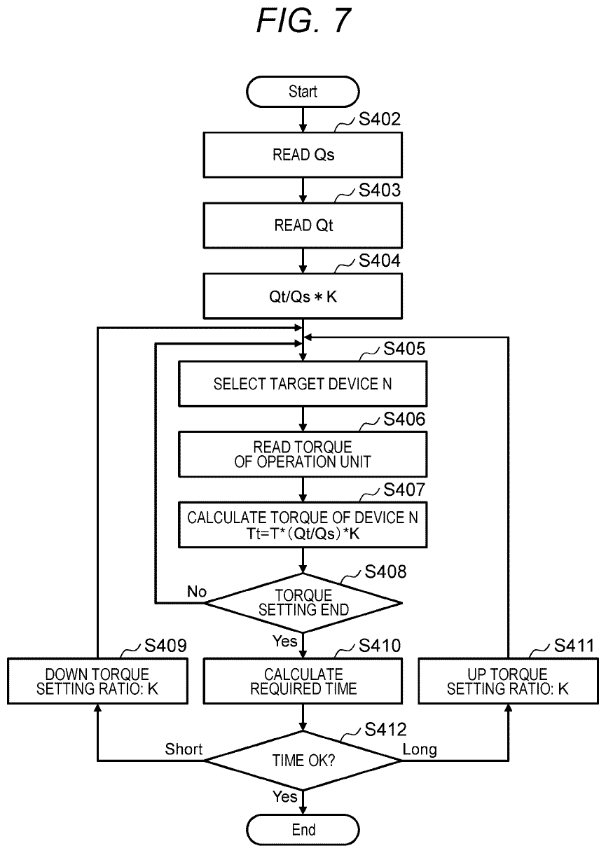

FIG. 7 is a flowchart illustrating details of a torque setting process (FIGS. 4, S104, 105, and 110). The controller reads standard production amount data Qs in S402 from the production amount parameter of the database 202, and reads planned production amount data Qt on the production planning date in S403.

In S404, the controller calculates the change ratio of the torque (practical torque) when the planned production amount is performed, to the standard torque based on the ratio of Qt with respect to Qs. The change ratio becomes (Qt/Qs)*K, where K is a constant.

In S405, the controller selects a predetermined industrial machine from the plurality of industrial machines, moves to S406, and reads the standard torque of each of the plurality of operation units of the selected device from the database 202. For example, when the controller selects the robot 1, the standard torque of each shaft of T11, T12, T13, T14, and T15 is read.

In S407, the controller calculates the actual torque of a movable portion by multiplying each standard torque by the torque ratio described above.

In S408, the controller checks whether setting of the practical torque has been executed for all the devices constituting the automatic work line. When it is denied, the controller returns to S405 and calculates the practical torque for the remaining devices. When the controller confirms S408, the controller simulates the production work of a target product of the planned amount based on the practical torque set for all the devices, and calculates the required time from the start of the work to the completion of the work (S410).

Then, the controller optimizes the practical torque. The controller compares the required time with the standard time. In a case where the required time exceeds the standard time (S412: Long), the controller increases a constant K by a predetermined amount (S411) in order to increase the torque ratio and increase the working speed, and returns to S405.

On the other hand, in a case where the required time is shorter than the standard time (S412: Short), the controller reduces the constant K by a predetermined amount (S409) in order to reduce the torque ratio and lower the work speed, and returns to S405.

As a result, the controller repeats S405 and the subsequent steps of the flowchart until it can be said that the required time has almost converged to the standard time (S412: Yes), determines the torque of each of the plurality of industrial devices constituting the automatic work line, and ends the flowchart.

According to the flowchart of FIG. 7, the control device dynamically limits the torque load applied to each industrial machine according to the backlash of daily work, so that the device can be operated at a torque sufficient to keep the production plan within the standard time. Therefore, the life of the industrial machine can be extended while maintaining work efficiency.

The setting module 203 continuously records the daily set practical torque in the database 202. Further, the setting module 203 continuously detects the acceleration of each operation unit of each of the plurality of industrial machines by a sensor and registers the acceleration in the database 202. Therefore, the setting module 203 may determine the practical torque based on the machine learning based on the record data.

In the embodiment described above, it has been described that the practical torque is set by uniformly suppressing the standard torque of each of the plurality of machine industrial machines constituting the automatic work line at the same ratio, but the degree of suppression of the torque may be changed among the plurality of devices.

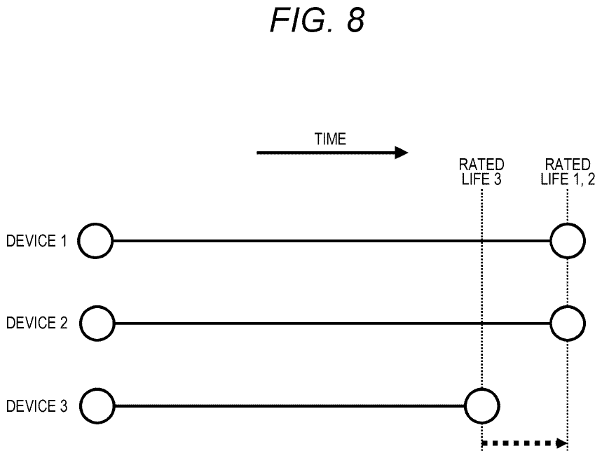

FIG. 8 is a schematic diagram illustrating a state in which the plurality of industrial machines are installed in parallel on the line 220. FIG. 8 illustrates a case where the rated life is determined for each of the plurality of industrial machines, and the rated life 3 is shorter than the rated lives 1 and 2. A case where the rated life 3 of the industrial machine 3 is extended to be the same as the rated lives 1 and 2 is assumed. In this case, in order to reduce the work allocation of the industrial machine 3 with respect to the industrial machines 1 and 2, the practical torque of the industrial machine 3 may be reduced as compared with that of the industrial machines 1 and 2.

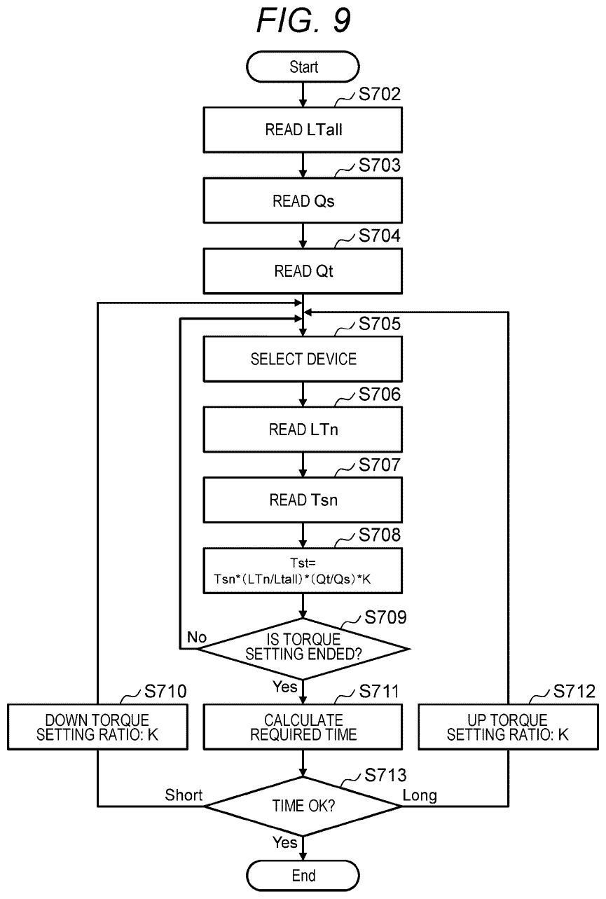

FIG. 9 is a flowchart for explaining this processing. This flowchart is an operation added to the flowchart of FIG. 4. The controller reads a target life Ltall of the automatic work line from the database 202 (S702), and further reads the standard production amount data Qs of the automatic work line from the database 202 (S703). Then, in S704, the controller reads the planned production amount data Qt from the database 202. Further, the controller selects one from a plurality of industrial machines (S705).

Then, the controller reads a rated life value LTn of the selected device from the database 202 (S706), and further reads the standard torque (standard torque for each of the plurality of operation units) Tsn (S707). Then, in S708, the controller calculates the practical torque of the industrial machine by calculating the torque change ratio according to the work plan and the life based on the above-described data read from the database and multiplying this by the standard torque Tsn. The torque change ratio may be, for example, as follows.

$$( LTn / LTall ) * ( Qt / Qs ) * K$$

(where K is a constant)

In S709, the controller determines whether the setting of the practical torque has been completed for all the industrial machines, and then proceeds to S711. In S711, the controller calculates the required time for the planned number of target objects to be produced by simulating the automatic work based on the practical torque set for each of the plurality of industrial machines.

In a case where the required time is longer than the standard time (S713: Long), the controller increases the constant K by a predetermined amount to increase the torque change ratio (S712), and returns to S705 to calculate the practical torque again.

In a case where the required time is shorter than the standard time (S713: Short), the controller lowers the constant K by a predetermined amount (S710) in order to lower the torque change ratio, and returns to S705 to calculate the practical torque again. As a result of S713, the required time converges to the standard time, and thus the controller ends the flowchart.

As described above, according to the flowchart of FIG. 9, in a case where a plurality of industrial machines are arranged in parallel in a line, and the life of some of the industrial machines is shorter than the life of the other industrial machines, the life of the plurality of industrial machines can be equalized by suppressing the torque of the industrial machine having a short life as compared with the torque of the other industrial machines. The same applies to not only a case where the plurality of industrial machines have different life but also a case where there is a difference in attributes other than the life, such as a difference in price and a difference in environmental load.

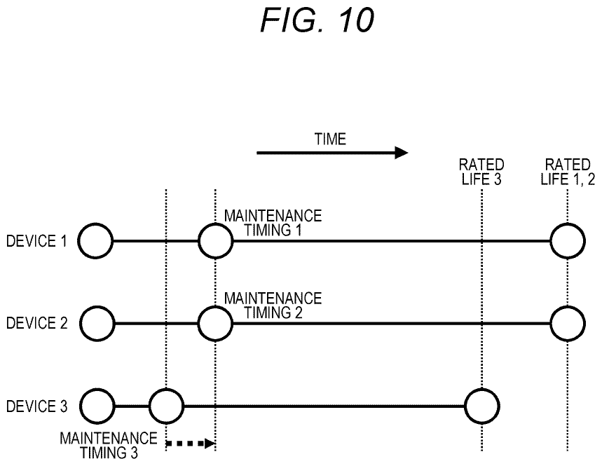

As one of attributes of the industrial machine, for example, there is a maintenance timing. FIG. 10 is a schematic diagram illustrating a state in which a plurality of industrial machines is installed in parallel in a line, and illustrates a case where a maintenance timing and the rated life are set for each of the plurality of industrial machines, and the maintenance timing 3 is shorter than the maintenance timings 1 and 2.

A case where the maintenance timing 3 of the industrial machine 3 is extended to be the same as the maintenance timings 1 and 2 is assumed. In this case, in order to set the work allocation of the industrial machine 3 to a low value than the industrial machines 1 and 2, the torque of the industrial machine 3 may be reduced as compared with the industrial machines 1 and 2. Note that it is also possible to shift the maintenance timing so that the maintenance load is not concentrated among the plurality of industrial machines.

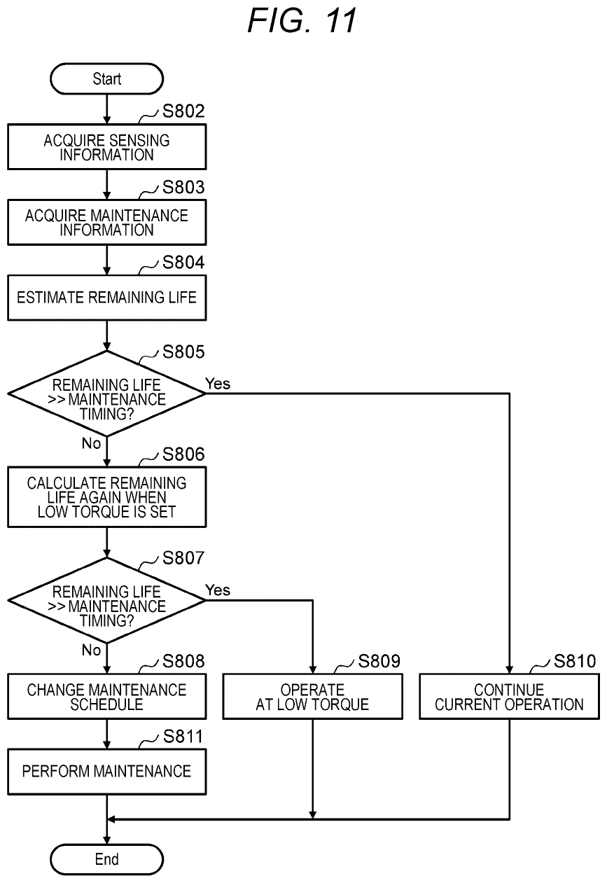

FIG. 11 is a flowchart for managing maintenance of a plurality of industrial machines. In S802, the controller acquires sensing information of each of the plurality of industrial machines, and further proceeds to S803 to acquire schedule information related to maintenance of each of the industrial machines from the database.

In S804, the controller estimates the remaining life of each of the industrial machines based on the sensing information (S802), and proceeds to S805. The controller compares the remaining life with the maintenance schedule (S803). The controller checks whether the remaining life reaches a time point that is a predetermined time or more after the maintenance timing. The controller performs the maintenance according to the schedule (S803) while continuing the current operation based on the standard torque or the practical torque (FIG. 4) (S810), assuming that the remaining life of the industrial machine does not need to be adjusted (S811) for the industrial machine in which the above check makes affirmative determination (S805: Yes).

When a negative determination is made in S805 (S805: No), the controller reduces the current torque of the industrial machine which is the target of the negative determination by a predetermined ratio to be low torque, and simulates the automatic work based on this to calculate the remaining life again (S806). The controller compares the remaining life with the maintenance schedule, and performs the same determination as that in S805 (S807). When the controller makes the affirmative determination (S807: Yes), the operation is switched to the operation based on the low torque (S809), and the maintenance is performed according to the schedule (S803) (S811).

In a case where the controller makes a negative determination (S807: No), the maintenance schedule is changed so that the maintenance timing is advanced (S808), the maintenance is executed based on the schedule (S811), and the flowchart is ended.

As described above, according to the flowchart of FIG. 11, it is possible to perform maintenance on a plurality of industrial machines substantially according to a predetermined schedule.

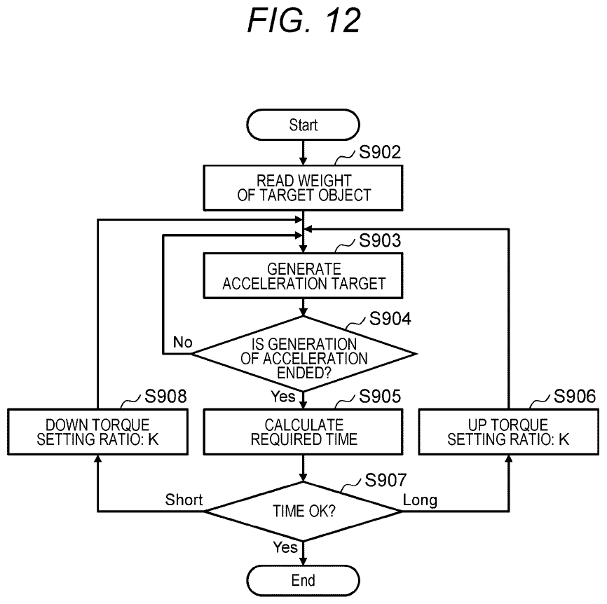

The flowchart of FIG. 12 describes the operation of the controller that optimizes the above-described torque (FIG. 4) based on the weight of the target object. The controller reads a weight Wn of the target object from the database 202 (S902), and generates an acceleration target An of the operation unit of the industrial machine (S903). The acceleration target An is calculated by An=K/Wn (K: constant) to be inversely proportional to the weight Wn.

The controller executes S903 until the acceleration target value of the industrial machine is generated for all the target objects (S904: No), and moves to S905 (S904: Yes).

In S905, the controller obtains torque based on the generated acceleration, and calculates the time required to complete the work by simulation of the work on the target object of the planned amount based on the torque.

The controller compares the required time with the target time, for example, the standard time. In a case where the former is longer than the latter (S907: Long), the controller increases the constant K by a predetermined amount in order to increase the torque (S906), and proceeds to S903. On the other hand, in a case where the former is shorter than the latter (short in S907), the controller reduces the constant K by a predetermined amount (S908). The controller determines that the necessary time converges to a set range with respect to the target time for the plurality of target objects and determines the acceleration for all the target objects (S907).

As described above, according to the flowchart of FIG. 12, since the torque of the industrial machine can be corrected in accordance with the weight of each of the plurality of target objects continuously moving on the line, it is possible to further improve the life of the industrial machine.

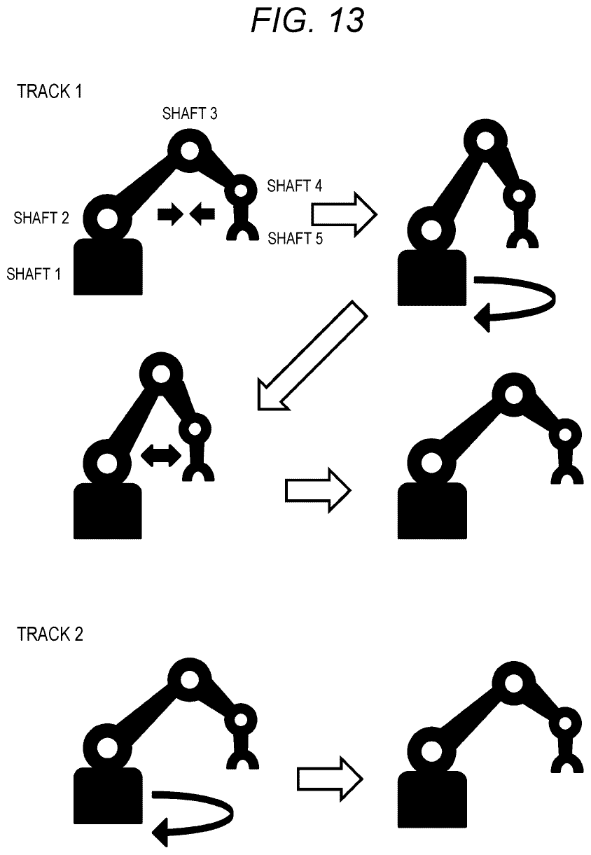

FIG. 13 is a model diagram related to a behavior of the five-axis robot. On the track 2, the robot moves the arm to a target position by operating only the horizontal rotation shaft (shaft 1). On the other hand, in the track 1, the robot moves the shaft 2, the shaft 3, and the shaft 4 to bring the arm into the slightly closed posture in Step1, rotates the shaft 1 in the horizontal direction in Step2, and moves the shaft 2, the shaft 3, and the shaft 4 to return the arm from the slightly closed posture to the original position in Step3.

In the case of the track 1, since the rotation radius can be reduced in the shaft 1 which is the horizontal rotation shaft, the torque in the shaft 1 can be reduced. On the other hand, the rotation of the shaft 2, the shaft 3, and the shaft 4 increases the torque on these shafts.

On the other hand, in the case of the track 2, the rotation radius is large in the shaft 1 that is the horizontal rotation shaft, and the torque on the shaft 1 increases, but the shaft 2, the shaft 3, and the shaft 4 do not rotate, and thus no torque is generated.

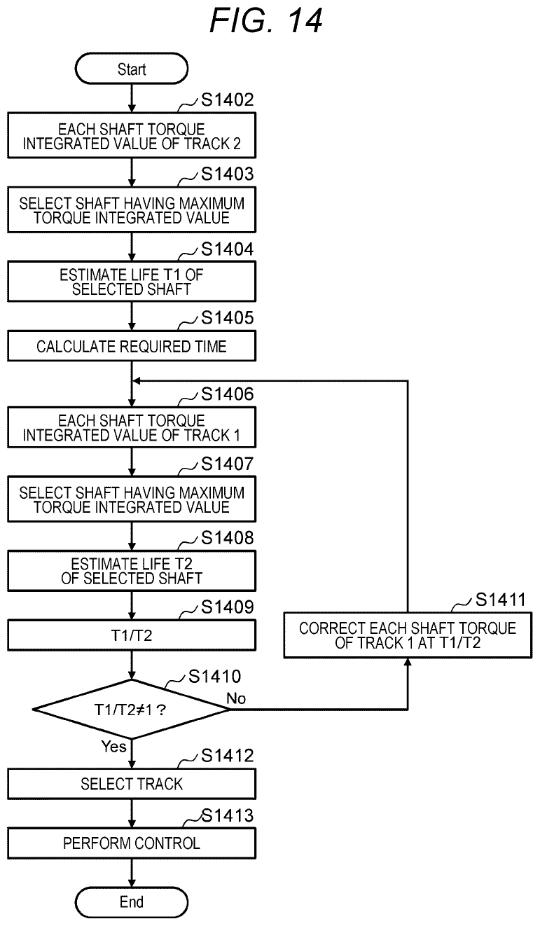

FIG. 14 is a flowchart for selecting the track 1 or the track 2. The controller calculates an integrated value of the load torque of each shaft in the track 2 based on the practical torque (FIG. 4: S106) (S1402). The controller selects the shaft having the maximum torque integrated value in S1403, and estimates the life from the integrated value of the selected shaft in S1404. The controller calculates the required time until the work of the planned amount is completed based on the set torque value in S1405.

The controller calculates an integrated value of the load torque of each shaft in the track 1 based on the standard torque (FIG. 4: S108) (S1406). In S1407, the controller selects the shaft having the maximum torque integrated value. In S1408, the controller estimates the life from the torque integrated value of the selected shaft, in S1408, the controller estimates the life from the torque integrated value of the selected axis, and in S1409, the controller compares the life calculated in S1404 with the life calculated in S1408.

In S1411, in a case where both are not equal, the controller changes the set torque value of each shaft of the track 1, and repeats S1406 to S1409. When the controller determines that the life calculated in S1404 is equal to the life calculated in S1408 (S1410), the controller selects the track having the larger work amount per hour between the track 1 and the track 2 in S1412, and controls the five-axis robot based on the track selected in S1413.

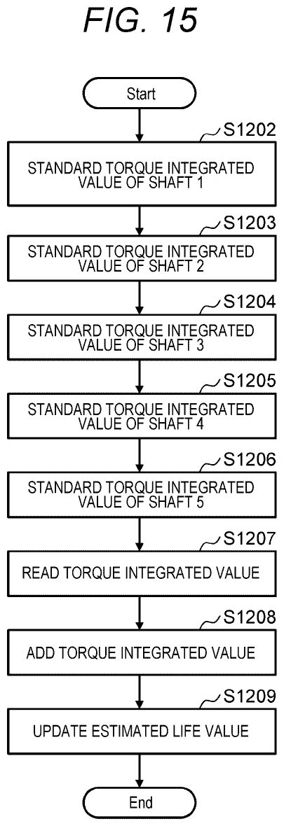

FIG. 15 is a flowchart for managing the life of each operation unit and each device of the industrial machine. The controller integrates the standard torque of the shaft 1 in a case where the load torque of the shaft 1 of the five-axis robot varies as illustrated in FIG. 5 by the cumulative rotation speed (S1202). The same applies to the other shafts 2 to 5 of the five-axis robot (S1203 to S1206). In S1207, the controller reads the torque integrated value of each shaft up to the planned date stored in the database 202. In S1208, the controller adds the torque integrated value up to the planned date of each axis and the torque integrated value of the planned date and registers the result of the addition in the database 202.

Note that the embodiment and various modifications described above are merely examples, and the present invention is not limited to these contents without the characteristics of the invention being impaired. Although various embodiments and modifications have been described above, the present invention is not limited to these contents. Other forms considered within the scope of the technical idea of the present invention are also included in the scope of the present invention.

### REFERENCE SIGNS LIST

200 control device
200A automatic work line
205 to 208 working machine
220 line

1. An automatic work line control device that controls an automatic work line including a plurality of mechanical operating devices, the automatic work line control device comprising:
means for generating a work: plan based on work instruction information including a work amount of a work plan target time unit of the automatic work line;
means for outputting the generated work plan; and
means for controlling torque of each of the plurality of mechanical operating devices over a target period of the work plan based on the work plan of each of the plurality of mechanical operating devices by the means for generating the work plan.

2. The automatic work line control device according to claim 1, wherein
the means for controlling the torque
reduces the torque of each of the plurality of mechanical operating devices from a standard value based on the work plan, and
drives each of the plurality of mechanical operating devices at the reduced torque until the work plan is completed.

3. The automatic work line control device according to claim 2, wherein
the means for controlling the torque
sets the torque of each of the plurality of mechanical feeding devices to the standard value so that the plurality of mechanical operating devices execute a standard amount of the work in a standard period,
obtains a planned amount of work from the work plan,
compares the planned amount with the standard amount, and
reduces torque of the plurality of mechanical operating devices from the standard value based on a result of the comparison.

4. The automatic work line control device according to claim 3, wherein
the means for controlling the torque, when it is determined that the planned amount is less than the standard amount as a result of the comparison, reduces the torque of each of the plurality of mechanical operating devices from the standard value so that each of the plurality of mechanical operating devices completes the work of the planned amount based on the standard period.

5. The automatic work line control device according to claim 3, wherein
the means for controlling the torque reduces the torque of each of the plurality of mechanical operating devices from the standard value based on a ratio of the planned amount with respect to the standard amount.

6. The automatic work line control device according to claim 2, wherein
the means for controlling the torque, when the torque of each of the plurality of mechanical operating devices is reduced from the standard value, sets a degree of reduction to be different among the plurality of mechanical operating devices.

7. The automatic work line control device according to claim 3, wherein
a life of some devices among the plurality of mechanical operating device devices is shorter than a life of other devices, and
the means for controlling the torque equalizes the life of each of the plurality of mechanical operating devices by suppressing the torque of the device having a short life as compared with the torque of the other device.

8. The automatic work line control device according to claim 3, wherein
a maintenance timing of some devices among the plurality of mechanical operating devices is shorter than a maintenance timing of other devices, and
the means for controlling the torque equalizes the maintenance timing of each of the plurality of mechanical operating devices by suppressing the torque of the device having a short maintenance timing as compared with the torque of the other device.

9. The automatic work line control device according to claim 3, wherein
the means for controlling the torque sets the torque of each of the plurality of mechanical operating devices based on a weight of each of a plurality of target objects that continuously move on a line.

10. A automatic work line control method that is a method for control of an automated work line including a plurality of mechanical operating devices, the automatic work line control method comprising:
by a controller that executes the control,
generating a work plan based on work instruction information including a work amount of a work plan target time unit of the automatic work line;
outputting the generated work plan; and
controlling torque of each of the plurality of mechanical operating devices over a target period of the work plan in accordance with the work plan of each of the plurality of mechanical operating devices.
